(19) United States
(12) Patent Application Publication
(10) Pub. No.: US 2002/0153691 A1
(43) Pub. Date: Oct. 24, 2002

(54) Driving mechanism for a wheelchair

(76) Inventors: Hsueh Sen Liao, Hsin Chu Hsien (TW); Tian Yow Hwang, Taichung City (TW)

Correspondence Address: DOUGHERTY & TROXELL, SUITE 1404, 5205 LEESBURG PIKE, FALLS CHURCH, VA, 22041, US

(21) Appl. No.: 09/838,293

(22) Filed: Apr. 20, 2001

(51) Int. Cl. B62M 1/14

(52) U.S. Cl. 280/250.1; 280/246

(57) ABSTRACT

A wheelchair having two driving mechanisms comprises a frame body formed from a plurality of links; an axle for supporting the frame body; two rear wheels connected to the two ends of the axle; and two driving mechanisms arranged on the two sides of the frame body, respectively, to synchronously drive the rotation of the two rear wheels, each of said two driving mechanisms comprising:

a sprocket disposed on the axle;

a pivotal member including a round plate and a handle, said round plate being provided with a central hole for insertion of a link in the front of the frame body;

an elastic member including a spring having two ends, one end being fixed to a link in the bottom of the frame body; and

a chain which is passed over the sprocket, and having one end pulled by the other end of the spring and another end pulled by the periphery of the round plate.

### BACKGROUND OF THE INVENTION

1. Field of the Invention

The present invention relates to a wheelchair, more particularly, to a wheelchair having a driving mechanism which may drive the wheelchair to go faster.

2. Description of the Related Art

Referring to FIG. 1 which shows a perspective view of a conventional wheelchair, a wheel-turning ring 1 is fixedly secured to the periphery of a rear wheel 3 by a plurality of connecting members 2. Thus, the wheel-turning ring 1 is spaced from the periphery of the rear wheel 3 to allow the user to hold and turn the wheel-turning ring 1 so as to advance the wheelchair. Most notably, the speed of the rotation of the griping ring 1 cannot be fast, because the user's hand has to touch the quickly rotating wheel-turning ring 1 and might be hurt. Therefore, the speed of the advancing movement of the wheelchair is controlled by the user.

### SUMMARY OF THE INVENTION

Accordingly, an object of the present invention is to provide a driving mechanism for a wheelchair which allows a user to advance the wheelchair faster without hurting his hand.

To achieve the object mentioned above, the present invention provides a wheelchair having two driving mechanisms comprising:

a frame body formed from a plurality of links;

an axle for supporting the frame body;

two rear wheels connected to the two ends of the axle; and

two driving mechanisms arranged on the two sides of the frame body, respectively, to synchronously drive the rotation of the two rear wheels, each of said two driving mechanisms comprising:

a sprocket disposed on the axle;

a pivotal member including a round plate and a handle, said round plate being provided with a central hole for insertion of a link in the front of the frame body;

an elastic member including a spring having two ends, one end being fixed to a link in the bottom of the frame body; and

a chain which is passed over the sprocket, and having one end pulled by the other end of the spring and another end pulled by the periphery of the round plate.

### BRIEF DESCRIPTION OF THE DRAWING

The above objects and advantages of the present invention will become more apparent by the following detailed description of a preferred embodiment in conjunction with the accompanying drawings, in which:

FIG. 1 shows a perspective view of a conventional wheelchair;

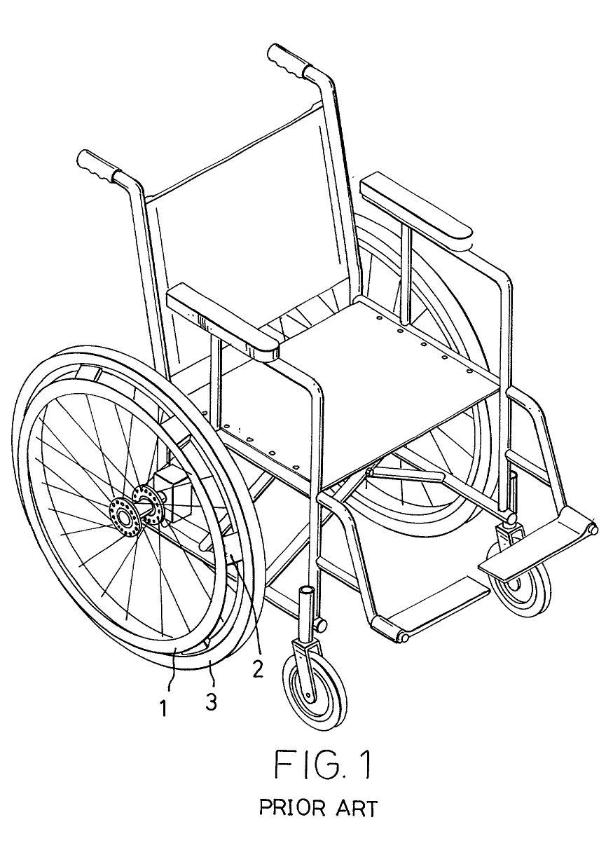

FIG. 2 shows a perspective view of a driving mechanism for a wheelchair according to the present invention;

FIG. 3 shows a side view of the driving mechanism for the wheelchair according to the present invention;

FIG. 4 shows a rear view of the driving mechanism for the wheelchair according to the present invention;

FIG. 5 shows an operational view of the driving mechanism for the wheelchair according to the present invention.

### DETAILED DESCRIPTION OF THE PREFERRED EMBODIMENT

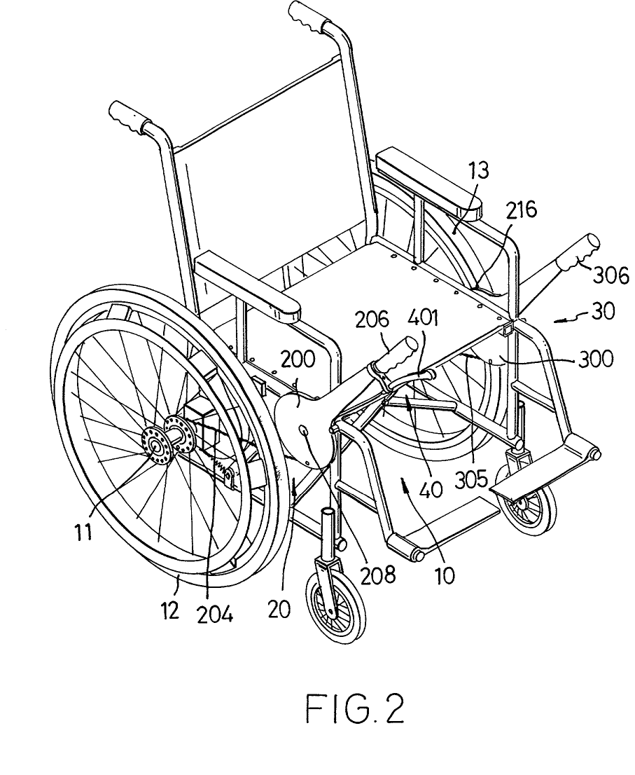

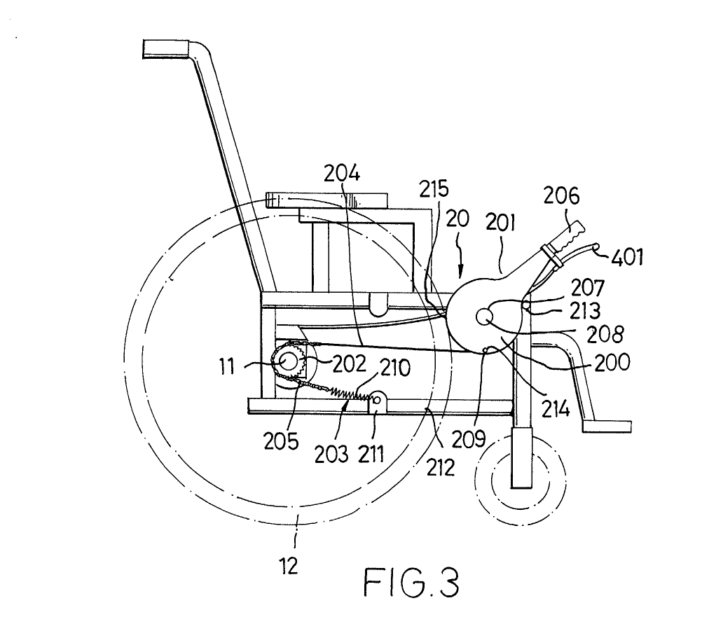

Referring now to FIGS. 2 and 3, a wheelchair having a driving mechanism according to the present invention is shown to comprise a frame body 10 formed from a plurality of links, an axle 11 for supporting the frame body 10, two rear wheels 12,13 connected to the two ends of the axle 11, respectively, and two driving mechanisms 20,30 which are respectively arranged on the two sides of the frame body 10 to synchronously drive the rotation of the two rear wheels 12, 13. The two driving mechanisms 20,30 have the same construction, and therefore, only one driving mechanism 20 arranged at one side of the frame body 10 will be described herein. Referring to FIG. 3 the driving mechanism 20 comprises a pivotal member 201, a sprocket 202, an elastic member 203, a cable 204, and a chain 205. The cable 204 is connected to chain 205. Said sprocket 202 is connected to an axle 11 of the wheelchair, and the two ends of the axle 11 are secured to the two rear wheels 12, 13.

The pivotal member 201 includes a round plate 200 and a handle 206. The round plate 200 is provided with a central hole 207 which is pivotally connected to a rod 208 fixed to a link in the front of the frame body 10, and a through bore 209.

The elastic member 203 includes a spring 210 having two ends, one end being fixed to a block 211 secured to a link 212 at the bottom of the frame body 10.

The chain 205 is passed over the sprocket 202 and the free end thereof is connected to one end of the spring 210 while the free end of the cable 204 is connected to the through bore 209 by a pin 214.

The driving mechanism according to this embodiment further comprises a positioning rod 213 a fixed to one link of the frame body 10. The positioning rod 213 functions to support the pivotal member.201 when the driving mechanism is not driven.

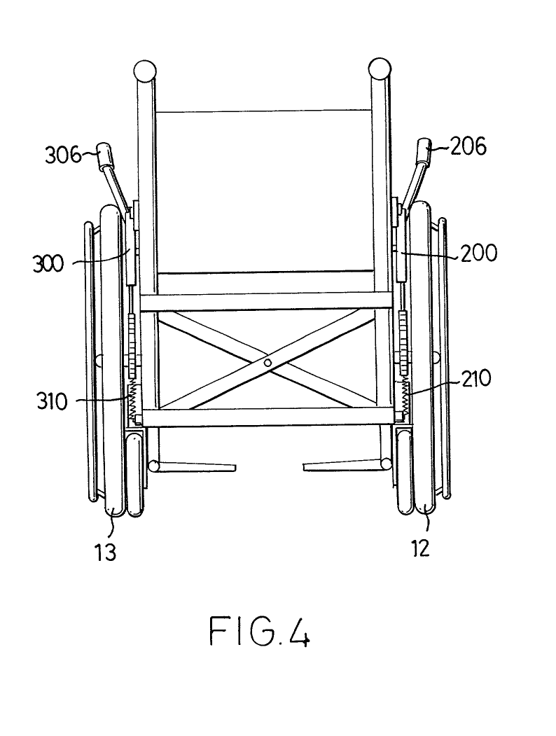

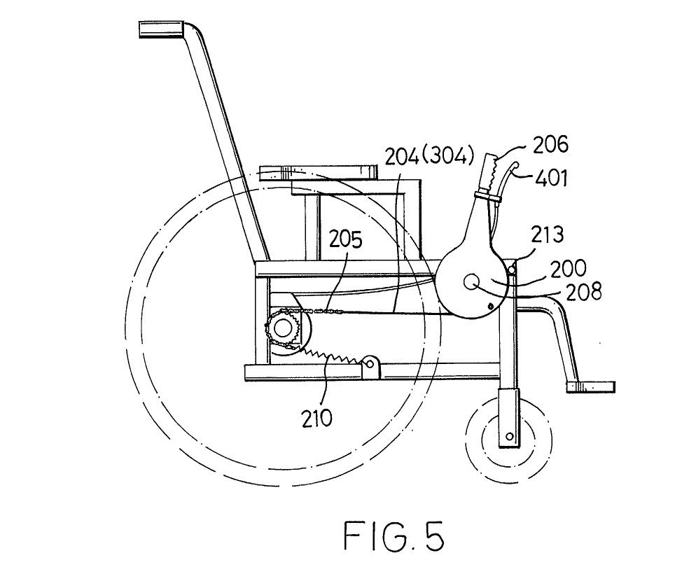

Referring to FIGS. 3, 4 and 5, when the user wishes to move the wheelchair at high speed, his two hands grip the handles 206 and 306, respectively, and move them in a direction toward himself. Consequently, the pivotal members 201 and 301 rotate around the rod 208 so that the pin 214 pulls the cables 204 and 304 causing the movement thereof along the periphery 215,216 of the round plates 200, 300. Thus, the cables 204, (304) pull the chains 205, 305, respectively. The movement of the chains 205,305 drives the rotation of the rear wheel 12,13 to advance the wheelchair, and the springs 210, 310 are stretched by the chains 205,305. When the handles 206,306 are not actuated by the user's hands. The restoring force of the springs 210,310 pulls the chains 205,305 to turn the original position thereof. The repeated operation of the handles as described enables the advancing movement of the wheelchair. The faster the handle operation is, the faster is the advancing movement of the wheelchair. A known braking system 40 is provided for reducing the speed or halting of the advancement of the wheelchair. The braking system 40 includes a braking rod 401 disposed near to the handlebars 206, 306 for the convenience of the user to reach for it when it is intended reduce the speed.

Therefore, the driving mechanism according to the present invention can achieve a fast advancing movement of the wheelchair without causing possible injury to the user's hands.

While there is shown and described herein certain specific structures embodying the present invention, it will be apparent to those skilled in the art that various modification and rearrangements of the parts may be made without departing from the spirit and scope of the underlying inventive concept.

1. A wheelchair having two driving mechanisms, comprising:
a frame body formed from a plurality of links;
an axle for supporting the frame body;
two rear wheels connected to the two ends of the axle; and
two driving mechanisms arranged on the two sides of the frame body, respectively, to synchronously drive the rotation of the two rear wheels, each of said two driving mechanisms comprising:
a sprocket disposed on the axle;
a pivotal member including a round plate and a handle, said round plate being provided with a central hole for insertion of a link in the front of the frame body;
an elastic member including a spring having two ends, one end being fixed to a link in the bottom of the frame body; and
a chain which is passed over the sprocket, and having one end pulled by the other end of the spring and another end pulled by the periphery of the round plate.

2. A wheelchair having a driving mechanism as claimed in claim 1, further comprising a positioning rod a fixed to the link in the front of the frame body for supporting of the pivotal member when the driving mechanism is not driven.

3. A wheelchair having a driving mechanism as claimed in claim 1, further comprising a cable, one end of which is connected to chain while the other end is secured to the periphery of the round plate.
